(19) United States
(12) Patent Application Publication
(10) Pub. No.: US 2005/0216401 A1
(43) Pub. Date: Sep. 29, 2005

(54) Method of and system for accounting and billing for royalty payments and the like due vendors for customer downloading of digital recorded media having embedded descriptive digital code "watermaking", such as music records, movies, software products and the like through the use of the established internet ISP gateway as a toll gate and billing service

(76) Inventor: Justice C. Rines, New York, NY (US)

Correspondence Address: RINES & RINES, 81 N. STATE STREET, CONCORD, NH, 03301, US

(21) Appl. No.: 10/810,542

(22) Filed: Mar. 27, 2004

(51) Int. Cl. G06F 17/60

(52) U.S. Cl. 705/40

(57) ABSTRACT

A technique for using the ISP, currently the consumer gateway for access to the Internet, also as a virtual “tollbooth” through which vendor-proprietary recorded media, such as music, movies, software, etc., each provided with embedded digital code identification, are passed to the subscribing consumer for downloading usage, with the ISP servicing the vendors by tracking the passage of the respective vendor media through the ISP gateway to the respective subscribing consumers and billing the respective consumers for the appropriate media vendor charges (royalties, etc.) as additions to the current ISP-consumer billing relationship. The billed vendors' charges are distributed to the respective vendors, with the ISP retaining a service fee ISP.

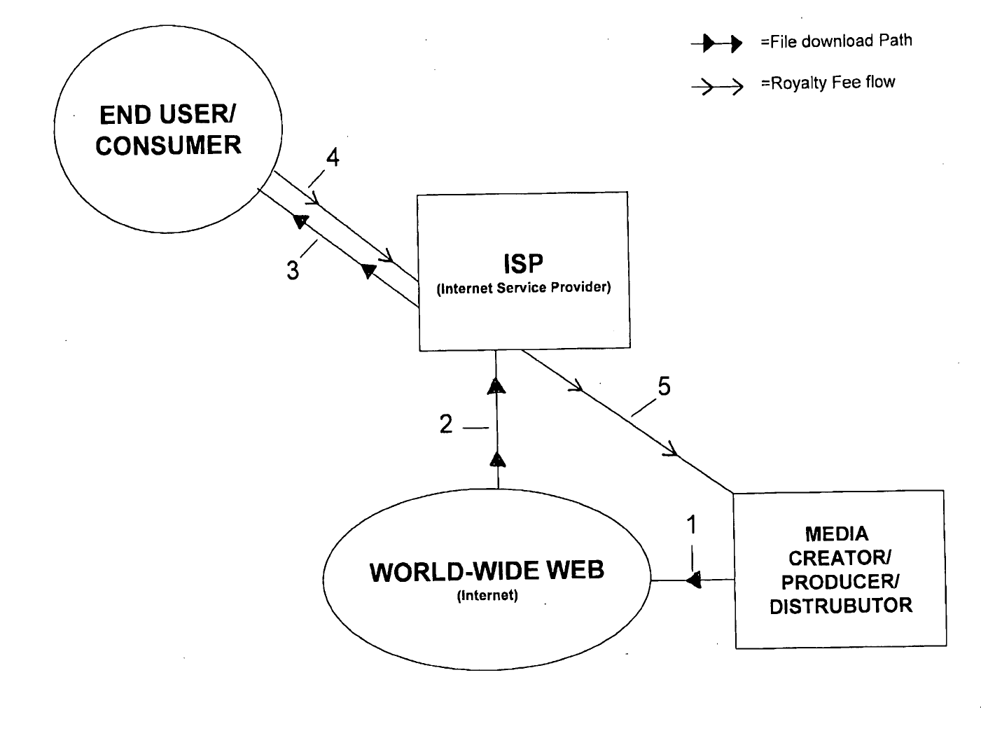

### FIELD

The present invention relates to the problems involved in the tracking and accounting to vendors for customer downloading, particularly on the Internet, of vendor proprietary digital media material such as music, movies, software, etc.; being especially directed not only to the minimizing of piracy, but also to simplifying the ease of charging for customer use.

### BACKGROUND

Very extensive systems have heretofore been developed and are currently being employed to try to address such problems, but, unfortunately, they are not as yet totally satisfactory and, in particular, do not provide a complete and easy solution specifically designed for vendors of music media, movies, software products and the like over the Internet.

Underlying the breakthrough technique provided by the present invention, is the concept of the use of the ISP (Internet Service Provider), currently the necessary Internet gateway for end-users (consumers or customers) to access the Internet and download media, also as a virtual tollbooth through which such media may pass—with appropriately descriptive or electronically readable identifying digital code virtual “watermarking” embedded in the respective media. Such will be monitored and detected by the ISP gateway in its tollbooth function and the appropriate charge of the media vendors will be applied to the end-user customer on the currently established ISP monthly or other billings involved in current ISP/consumer billing relationships.

The ISP may subtract or withhold a service fee(s) for itself and then pass the balance of the charger or percentages thereof to the vendor(s) or entities from which the media originated.

Such a concept and practice, and the advantages following therefrom, are not provided by any of the myriad of prior approaches being currently employed, and proposed, as will now be briefly summarized.

Turning first to EADDTD—Encoded Archival Description—this is a nonproprietary encoding standard for machine-readable finding aids such as inventories, registers, indexes, and other documents created by archives, libraries, museums, and manuscript repositories to support the use of their holdings. This technique provides
1) the ability to present extensive and interrelated descriptive information found in archival finding aids;
2) the ability to preserve the hierarchical relationships existing between levels of description;
3) the ability to represent descriptive information that is inherited by one hierarchical level from another;
4) the ability to move within a hierarchical informational structure; and
5) support for element-specific indexing and retrieval.

This technique, however, does not appear to apply easily to media such as the music, movies, software, etc. of specific concern in the problems solved by the present invention, nor to the total elimination of piracy thereof. It also does not apply to increasing the ease-of-use of online media providers, nor does it provide a method of automatically charging royalties due from downloads via the supplemental use of the previously established and current consumer/ISP relationships.

Another available tool is the use of CPRM—Content Protection for Recordable Media. This involves a mechanism for controlling the copying, moving and deletion of digital media on a host device, such as a personal computer, or other digital player. It is already used in specific removable media, and is now being proposed for inclusion in any ATA specification, for hard drives. Each CPRM—compatible ATA hard drive is individually signed, and authenticates the playback and movement of files on the device against a central server using CPRM-compliant software.

For solving the total problems underlying the present invention, however, this approach falls short, applying, indeed, only to newly purchased hardware, thus compromising the scope of use of hardware purchased by consumers. It also does not apply to increasing the ease-of-use of online media providers, nor does it provide a method of automatically charging royalties due from downloads via the previously established consumer/ISP relationship.

Another prior system is EMMS—Electronic Media Management System. EMMS provides delivery of digital assets, flexible digital rights management, and helps protect assets through their entire lifecycle—for business to business (B2B), business to employee (B2E) or business to consumer (B2C) commerce. It can also facilitate the integration of DRM services into existing web applications, including e-commerce applications, enterprise portals and end user support.

This approach limits the scope of the use consumers have with regard to the media they purchase. It also does not allow for automatic accounting and collection of royalties due from downloads as earlier discussed.

Considering next the activities of NCITS L8 (formerly X3L8), on Data Representation, this is a technical committee of the National Committee on Information Technology Standards (NCITS)—Accredited Standards Committee X3—which is accredited by ANSI, the American National Standards Institute. NCITS L8 establishes standards for specifying and standardizing data. The focus of the work is on establishing ways to describe data to facilitate human use and to enable intelligent computer processing. Data is described through use of metadata (data about data). Metadata issues covered by the committee include naming, identifying, defining, classifying, and registering. The standards developed by the committee are to be used in many areas, such as: Electronic Data Interchange (EDI); data administration; information management; application development for information systems; and data access and interchange via the World Wide Web (WWW) and National Information Infrastructure (NII).

Members of the committee are reported as developing a metamodel for viewing by humans and for guiding machine processing. The metamodel can also be used as a scheme for CASE tools and repositories so that system developers and data specialists can record what they know about specific data collections. A part of the standards work also addresses how to set up a registration authority that can standardize data for any domain of discourse, such as an organization or an industry. The committee works at the conceptual and logical levels of data, but not at lower levels involving representation addressing issues such as storage on disk in packed decimal encoding.

Much of this work is pursued simultaneously at the National (American National Standards Institute (ANSI)) and International (International Organization for Standards (ISO)) levels. NCITS L8 is concerned with the development of proposed standards (notably ISO/TEC 11179) which will facilitate the standardized naming, definition, and description of data elements. It is intended that ISO/IEC 11179 would support other ISO/ANSI/UN standards of larger scope which are concerned with information repositories (X3H4), EDI systems, GIS (Geographic Information Systems), e.g., US Federal Geographic Data Committee, CASE Data Interchange Formats (CDIF), etc.

As for the matter of assistance in solving the specific problems of the present invention, these activities appear merely to provide a set of standards to which applications, etc. must adhere. The hope is that certain media can be identified via the standards and their use can therefore be restricted. This does not, however, provide a specific mechanism for preventing piracy. It also does not apply to increasing the ease-of-use of online media providers nor does it offer a method of automatically charging royalties due from downloads, nor for using such via the previously established consumer/IPS relationship as employed by the present invention.

The invention, on the other hand, unlike the above and other prior approaches, to the contrary, provides a novel method that:
Ensures that royalties or other payments for downloaded media use are accounted for and collected via the already established ISP-consumer relationship;
Provides increased ease-of-use of online (Web-based) media vendors (i-tunes, real networks, software vendors, etc.); and
Avoids necessity of altering hardware, software or media profiles and/or scope of use.

### OBJECTS OF INVENTION

A principal object of the invention, accordingly, is to provide what prior efforts have failed to provide, as above explained, namely, a new and improved method of and system for tracking, accounting for and enabling billing for the Internet downloading of vendors' music, movies, software and related recorded digital media carrying respective embedded digital code “watermarked” identification, through the passing of the media through existing ISP Internet gateways that will, under the invention, now also serve the further function of a virtual tollgate, tracking such passage and monitoring the embedded codes and passing on to the customer via the present ISP/customer billing relationship, vendor royalty or related billings as part of the present ISP/customer billing—also enabling the extracting of a service charge for the ISP and the distributing of the balance due to the appropriate vendors.

A further object is to provide an easy-to-use new business method for the tracking, payment and collection of royalties for Internet downloading of vendors' media, and a new business service opportunity for the ISP.

Other and further objects will be explained hereinafter and are more particularly delineated in the appended claims.

### SUMMARY

In summary, however, from one of its broader view points, the invention embraces a method of Internet controlling, tracking and billing for the usage of vendor digital recorded media by subscribing downloading consumers, that comprises, enabling subscribing Internet consumers to access an established ISP gateway under a predetermined ISP/consumer service billing relationship; embedding the respective vendor media with identifying digital code watermarking; passing through said ISP gateway the respective code-embedded vendor media to the respective subscribing consumers for downloading; and implementing said ISP gateway also to serve as a media tollbooth, tracking and identifying the respective code-embedded vendor media passing through the ISP gateway to the respective subscribing consumers and automatically adding to said predetermined ISP/consumer billing, the appropriate further billing charges of the respective media vendors for such respective consumer downloading usage. The ISP may distribute the vendor charges or credits therefore to the respective vendors and retain or separate charge for fee service.

Preferred and best mode designs and implementations for the practice of the invention are hereinafter presented in detail.

### DRAWINGS

The invention will now be described in connection with the accompanying drawing, the single FIGURE of which presents a block functional system and information flow diagram of a preferred implementation.

### PREFERRED EMBODIMENT(S) OF INVENTION

Referring to the drawing, an established Internet Service Provider is generically represented at ISP and is shown conventionally interfacing with the Internet World-Wide Web and with subscribing consumer/end users, so labeled, for whom the ISP provides Internet accessing gateway services under a predetermined ISP/consumer contract billing relationship, for such services often involving monthly billing payments.

As before explained, the invention expands the ISP-consumer relationship in a manner that provides what is believed to be a rather elegant and simple solution to the problem of pirating proprietary material over the Internet and the insuring of fair compensation to the creators and producers of such material—and with the creating of a further business service opportunity for the ISP as well.

While the invention is more broadly applicable, as before discussed, for purposes of illustration and also because it is a very serious current world-wide problem, the description of the functioning of the invention will now be more specifically presented with its exemplary application to recorded digital music media and the like. All media producers however, including record labels, movie houses, software producers, etc. are losing money to the tune of billions of dollars annually because of “illegal” downloads.

The philosophy underlying the present invention calls for the conceptualization of a technique by which Internet download revenues due vendors can be strictly accounted for and unbilled and/or collected for the vendor—and via the already established ISP-consumer billing relationship.

Since the ISP is a necessary gateway to access the Internet and obtain media files via download, the invention takes advantage of supplementarily using this unavoidable gateway also as a kind of virtual tollbooth—analogous somewhat to the “E-Z Pass” on today's motor highways and its automatic car code identification and credit card billing process.

Thus, in the drawing, the recorded digital media vendor, illustrated as the “Music Creator/Producer/Distributor” of digital music records, is shown downloading the proprietary media files on the Internet at 1, access to which by the subscribing consumer is shown through the paths 2 and 3 to and from and through the ISP gateway. Thus, the respective proprietary media vendor pieces are passed through the ISP gateway as a service for the vendors and to the subscribing consumer for download usage.

Now that the invention has imbued the ISP gateway with the supplemental function of serving as a proprietary media file “tollbooth”, several necessary implementations are required to perform this added ISP function. First, each pre-recorded digital media record must be pre-provided with an embedded digital-code identification as by known “watermark” technology heretofore used, for example, for copyright notices and the like. Secondly, the “tollgate” ISP must be provided with an automatic code reader or detector to identify each respective media record embedded digital code as it passes through the gateway, and also to control the process. Third, the appropriate vendor charge (royalty, etc.) is to be applied to the subscribing consumer/end-user simply as an additional item to the current monthly ISP service bill. The vendors' charged royalty fee flow, for example, is schematically shown at 4 passing through the ISP in its added “tollbooth” function for the benefit of and distribution to the vendor, as represented along path 5.

Thus, each time a piece of media, such as a music record, passes through the toll, the respective embedded digital identification code is detected by the S/P gateway implementation, and the appropriate than to charge is applied as a supplement to the end-users monthly ISP bill. The ISP may subtract a service fee for itself and then remit or otherwise distribute the vendors' fee, as at 5, along to the music producer or other entity from which the media record originated.

Simply, and in summary, the user unloads music media through the ISP gateway, and the respective embedded media code registers with the ISP, enabling the vendors' a fee to be charged to the established consumer monthly ISP bill, with the fee passed on, minus service charge, to the music creator, producer, label, artists, etc.

Further modifications will occur to others, skilled in this art, including the application of the concepts of the invention to other types of proprietary and other digital recorded media as previously outlined, and such are considered to fall within the spirit and scope of the invention as defined in the appended claims.

1. A method of Internet controlling, tracking and billing for the usage of vendor digital recorded media by subscribing downloading consumers, that comprises, enabling subscribing Internet consumers to access an established ISP gateway under a predetermined ISP/consumer service billing relationship; embedding the respective vendor media with identifying digital code watermarking; passing through said ISP gateway the respective code-embedded vendor media to the respective subscribing consumers for downloading; and implementing said ISP gateway also to serve as a media tollbooth, tracking and identifying the respective code-embedded vendor media passing through the ISP gateway to the respective subscribing consumers and automatically adding to said predetermined ISP/consumer billing, the appropriate further billing charges of the respective media vendors for such respective consumer downloading usage.

2. The method of claim 1 wherein such respective further billing charges for respective consumer downloading usage are distributed or credited amongst the respective appropriate media vendors.

3. The method of claim 2 wherein the ISP gateway retains a service fee from said further billing charges.

4. The method of claim 1 wherein the media are selected from the group consisting of music records, movies and software products.

5. The method of claim 2 wherein the media are music records, and the distribution includes to the respective music record vendors.

6. The method of claim 5 wherein the distribution also includes royalties and related payments to performing artists and musicians, composers and record producers and distributors.

7. A method of Internet service for usage of vendor digital recorded media by subscribing downloading consumers, that comprises, enabling subscribing Internet consumers to access an established ISP gateway under a predetermined ISP/consumer relationship; and implementing said ISP gateway also to direct passage of said vendor digital recorded media through said gateway to the respective subscribing consumers, while performing the further function of a tollbooth as a service to vendors and customers for tracking the digital recorded media passing through said gateway.

8. The method of claim 7 wherein said tollbooth function includes collecting or billing for vendor charges for such downloading.

9. The method of claim 8 wherein said billed vendor charges are distributed, credited or allocated to the respective vendors, with said ISP gateway retaining a service charge.

10. The method of claim 7 wherein said tracking is aided by respective media-embedded digital identifying code readable by said ISP gateway as the respective recorded media pass therethrough.

11. A system for Internet controlling, tracking and billing for the usage of vendor digital recorded media by subscribing downloading consumers, having, in combination with an established ISP gateway from the Internet, means for enabling subscribing Internet consumers to access the established ISP gateway under a predetermined ISP/consumer service billing relationship; means for enabling the vendors to download their respective media, into the Internet, with each respective vendor media being embedded with respective identifying digital code watermarking; means for passing through said ISP gateway the respective code-embedded vendor media to the respective subscribing consumers for downloading; and means for implementing said ISP gateway also to serve as a media tollbooth, with means for tracking and identifying the respective code-embedded vendor media passing through the ISP gateway to the respective subscribing consumers and means for automatically adding to said predetermined ISP/consumer billing, appropriate further vendor billing charges of the respective media vendors for such respective consumer downloading usage.

12. The system of claim 11 wherein such further respective vendor billing charges for respective consumer downloading usage are distributed or credited amongst the respective appropriate media vendors.

13. The system of claim 12 wherein the ISP gateway retains a service fee from said further billing charges or otherwise.

14. The system of claim 11 wherein the media are selected from the group consisting of music records, movies and software products.

15. The system of claim 12 wherein the media are music records, and the distribution includes to the respective music record vendors.

16. The system of claim 15 wherein said distribution also includes royalties and related payments to performing artists and musicians, composers and record producers and distributors.

17. A system of Internet service for usage of vendor digital recorded media by subscribing downloading consumers, having, in combination with an established ISP gateway from the Internet, means for enabling subscribing Internet consumers to access the established ISP gateway under a predetermined ISP/consumer relationship; and means for implementing said ISP gateway also to direct vendor digital recorded media through said gateway to the respective subscribing consumers, while performing the further function of a tollbooth for the vendors for tracking the digital recorded media passing through said gateway.

18. The system of claim 17 wherein said tollbooth function includes means for collecting, billing or crediting for vendors, the charges for such downloading.

19. The system of claim 18 wherein said vendor charges are distributed to the respective vendors, with said ISP gateway retaining or otherwise making a service charge.

20. The system of claim 17 wherein said tracking is aided by providing embedded digital-code identification in said media, and by means for detecting such code in said ISP gateway as the respective code-embedded recorded media pass therethrough.
